(19) United States
(12) Patent Application Publication
(10) Pub. No.: US 2014/0055271 A1
(43) Pub. Date: Feb. 27, 2014

(54) APPARATUSES, SYSTEMS AND METHODS FOR TRACKING MEDICAL DEVICES AND USE THEREOF

(71) Applicant: BloXR Corporation, Salt Lake City, UT (US)

(72) Inventors: Prataprai Chowdhary, Taylorsville, UT (US); Ashok C. Khandkar, Salt Lake City, UT (US)

(73) Assignee: BloXR Corporation, Salt Lake City, UT (US)

(21) Appl. No.: 14/069,353

(22) Filed: Oct. 31, 2013

Related U.S. Application Data
(63) Continuation-in-part of application No. 13/872,009, filed on Apr. 26, 2013.
(60) Provisional application No. 61/638,845, filed on Apr. 26, 2012.

(51) Int. Cl. G08B 21/18

(52) U.S. Cl. CPC G08B 21/18
USPC 340/600

(57) ABSTRACT

Apparatuses, systems and methods for tracking medical equipment, or one or more medical devices, such as radio-opaque shields, are disclosed. Use of the medical device(s) may be tracked. Withdrawal of the medical device(s) from service for maintenance, other service and/or validation may be tracked. When a tracked medical device comprises a radio-opaque shield, the cumulative exposure of the medical device or an individual or object shielded by the medical device to ionizing radiation may be tracked, as may the cumulative amount of ionizing radiation attenuated by the medical device. Methods for actively or passively tracking one or more medical devices until the arrival of a time for a predetermined, or scheduled, event are also disclosed, as are methods for performing predetermined events.

### CROSS-REFERENCE TO RELATED APPLICATION

This application is a continuation-in-part of U.S. patent application Ser. No. 13/872,009, filed on Apr. 26, 2013 and titled “APPARATUSES, SYSTEMS AND METHODS FOR TRACKING THE STATUS OF MULTIPLE MEDICAL DEVICES” (“the '009 application”), in which a claim for the benefit of priority was made under 35 U.S.C. §119(e) to the Apr. 26, 2012 filing date of U.S. Provisional Patent Application No. 61/638,845, titled “APPARATUSES, SYSTEMS AND METHODS FOR TRACKING THE STATUS OF MULTIPLE MEDICAL DEVICES” (“the '845 Provisional application”). The entire disclosures of the '845 Provisional application and the '009 application are, by this reference, incorporated herein.

### TECHNICAL FIELD

This disclosure relates generally to apparatuses, systems and methods for tracking and providing reminders of predetermined events, or scheduled events, for medical equipment, such as shields for limiting an individual's exposure to ionizing radiation. More specifically, this disclosure relates to a system in which individual identification and reminder apparatuses are associated with the individual pieces of medical equipment that are being tracked. In addition, the present invention relates to methods in which individually tracked medical devices may be inspected, validated, maintained or removed from service.

### SUMMARY

In various aspects and embodiments, the disclosed subject matter relates to apparatuses, systems and methods for keeping track of the status of various pieces of medical equipment within a particular setting, such as a hospital or another medical facility. The status of each medical device may be monitored in an active manner or a passive manner. In passive monitoring, one or more individuals in a healthcare setting may only be required to take action when provided with notice that a particular piece of medical equipment is due for inspection, validation, maintenance or to be removed from service.

According to one aspect, notice that a particular piece of medical equipment is due to be at least temporarily removed from service, such as for inspection, validation, maintenance or disposal (in which case removal would be permanent, of course), may be provided to an individual by way of a tracking device, or “audit tag,” associated with that piece of medical equipment (e.g., that was previously secured to the medical device, that is integrated into the medical device, etc.). A tracking device may be self-contained or part of a larger system or network.

In embodiments where the tracking device is self-contained, it may include a securing element, a monitoring element, an indicator and a portable power source, among other possible elements. The securing element may be configured to secure the tracking device to a piece of medical equipment, or a medical device. The monitoring element keeps track of one or more parameters from a first event (e.g., placement of a new medical device into service, placement of a recently inspected, validated or serviced medical device back into service, etc.) to a second event (e.g., a set time (date) on which the medical device is to be at least temporarily removed from service, when a radio-opaque shield has been exposed to a cumulative validation limit of ionizing radiation, when an individual with whom the radio-opaque shield is used has been subjected to a cumulative limit of ionizing radiation (e.g., a daily limit, a weekly limit, a monthly limit, an annual limit, etc.), etc.). The indicator, which may also be referred to as an “alarm,” may provide a user perceivable output, which may comprise a visible output (e.g., a light, a text message, etc.), an audible output (e.g., a beep, buzzer, voice message, etc.) and/or a tactile output (e.g., vibration, etc.). The portable power supply may provide power to the clock and the indicator, enabling them to operate. In some embodiments, a self-contained tracking device may also include a unique identifier, which may be used to enable an individual to manually determine a current status of the piece of medical equipment to which the tracking device has been assigned.

In some embodiments, the monitoring element may include a clock. The clock keeps track of, or counts down from, the time that has passed from the first event to the second event. A clock may provide information about, or dictate, when the second event will occur (e.g., when the point in time has arrived at which the medical device is to be checked, maintained or otherwise serviced, revalidated, etc.).

In addition to or instead of tracking the amount of time a medical device has been in service since its manufacture, validation, revalidation, or the like, a tracking device may be configured to track use of the medical device. As an example, a tracking device that is configured for use with a shield that attenuates ionizing radiation (e.g., x-rays, gamma radiation, etc.), which may also be referred to herein as a “radio-opaque” shield, may keep track of a cumulative amount of ionizing radiation to which the radio-opaque shield is exposed, a cumulative amount of ionizing radiation attenuated by the radio-opaque shield (e.g., by comparing an amount of ionizing radiation to which a radio-opaque shield is exposed to an amount of ionizing radiation to which an object or body covered by the radio-opaque shield is exposed, etc.) and/or a combination of the foregoing. The monitoring element of such a tracking device may include at least one radiation detector, or dosimeter.

In embodiments where the monitoring element of a tracking device includes a radiation detector, the radiation detector may be positioned and used to determine one or more of an amount of ionizing radiation to which the medical device has been exposed, an amount of ionizing radiation the medical device has attenuated and an amount of ionizing radiation to which an individual or objected shielded by the medical device has been exposed. To provide consistency in such measurements between two or more medical devices of the same type, or from one individual or shielded object to another, placement and/or orientations of the tracking devices and their radiation detectors may be consistent or substantially consistent among medical devices of the same type (e.g., a particular type of radio-opaque shield, such as an apron, a thyroid collar, a cap, etc.).

In embodiments where the tracking device is part of a larger monitoring system, the tracking device may include a securing element, a processor, a unique identifier, a wireless communication element, an indicator, a power supply and, optionally, a monitoring element. The securing element, the monitoring element (if any), the indicator and the power supply may operate as disclosed previously herein. The unique identifier may enable an individual to distinguish the tracking device or its assigned medical device from other pieces of identical medical equipment, it may enable an individual to manually determine the current status of the piece of medical equipment to which the tracking device has been assigned (i.e., attached) or it may enable the monitoring station to distinguish the tracking device from other tracking devices that are part of the same system. The processor may control operation of various elements of the tracking device, including the indicator. The wireless communication element may be configured to enable the processor to communicate with a remote monitoring station, which, in turn, may be configured to communicate with a plurality of tracking devices in a particular healthcare setting. In embodiments where evaluation of the medical device is based on time, a clock of the processing element may keep track of time, while in other embodiments, the time remaining until a particular piece of medical equipment is due for at least temporary removal from service may be kept by the monitoring station. In embodiments where evaluation of the medical device is based upon exposure to ionizing radiation and, thus, the tracking device includes a monitoring element that comprises at least one radiation detector, the radiation detector(s) of the tracking device may keep track of cumulative exposure of the medical device or an individual or object shielded by the medical device to ionizing radiation over time, the radiation detector(s) may keep track of the cumulative amount of ionizing radiation attenuated by the medical device over time, or the monitoring station may maintain a running total of the amount of ionizing radiation to which the tracking device has been exposed (e.g., total exposure, total attenuation, etc.).

According to another aspect, a medical device may include a tracking device, which provides a user with an indication of when the medical device is scheduled to be at least temporarily removed from service, or when the medical device should otherwise be at least temporarily removed from service. The tracking device may be removably secured to the medical device, or it may be integrated into the medical device. Such a configuration may ensure consistent or substantially consistent placement and/or orientation of the tracking device from one medical device of a particular type and/or configuration to another medical device of the same type and/or configuration. Tracking devices that incorporate teachings of this disclosure may be used in connection with a variety of different types of medical devices, including medical devices that are configured to periodic inspection, validation, maintenance or other activities. As indicated previously, in a specific embodiment, the medical device may comprise a radio-opaque shield.

A variety of methods are also disclosed. In some methods, a tracking device may be provided to an individual (e.g., a person using the assigned medical equipment, a person tasked with inventory control responsibilities, a person responsible for ensuring that the medical equipment is in compliance with inspection, compliance and/or validation requirements, etc.) for attachment to an individual piece of medical equipment. In embodiments where the medical device is configured to attenuate ionizing radiation and the tracking device will monitor radiation exposure and/or attenuating of ionizing radiation, the tracking device may be attached to a predetermined location on the medical device, which may ensure consistent or substantially consistent measurements from one use of the medical device to another use of the medical device, and between other medical devices of the same type. Once attached to an assigned piece of medical equipment, the individual may actively or passively monitor the status of that piece of medical equipment. More specifically, the tracking device or a system of which the tracking device is a part, rather than the individual, may keep track and determine when an event (e.g., the arrival of a set time, a parameter of cumulative use of the medical device has reached a predetermined threshold, etc.) at which that piece of medical equipment should be at least temporarily removed from service, or at which an individual's exposure to ionizing radiation should be limited or terminated for a period of time (the remainder of the day, week, month, year, etc.). As that event approaches, or at the occurrence of that event, the tracking device may provide a user perceptible signal to indicate that it is time to at least temporarily remove the medical device from service or limit or terminate the individual's exposure to ionizing radiation for a period of time. The user perceptible signal may include an electronic message, a visible signal (e.g., a blinking light, etc.), an audible signal or a tactile signal (e.g., vibration, etc.). Once the medical device has been removed from service, it may be inspected, validated, serviced or permanently removed from service (e.g., disposed of, etc.).

Other aspects, as well as various features and advantages of various aspects, of the disclosed subject matter will be apparent to those of ordinary skill in the art though consideration of the ensuing description, the accompanying drawings and the appended claims.

### BRIEF DESCRIPTION OF THE DRAWINGS

In the drawings:

FIG. 1 depicts an embodiment of a self-contained tracking device that may be used to track the status of a piece of medical equipment;

FIG. 2 depicts an embodiment of a tracking device that operates as part of a system for monitoring the statuses of a plurality of medical devices;

FIG. 3 schematically illustrates a system in which tracking devices such as those depicted by FIG. 2 may be used; and

FIG. 4 shows attachment of a tracking device to a piece of medical equipment—depicted as a shield for attenuating ionizing radiation.

### DETAILED DESCRIPTION

A tracking device, or audit tag, may enable active of passive monitoring of the status of a medical device. The tracking device may be self contained, or it may be part of a larger tracking system.

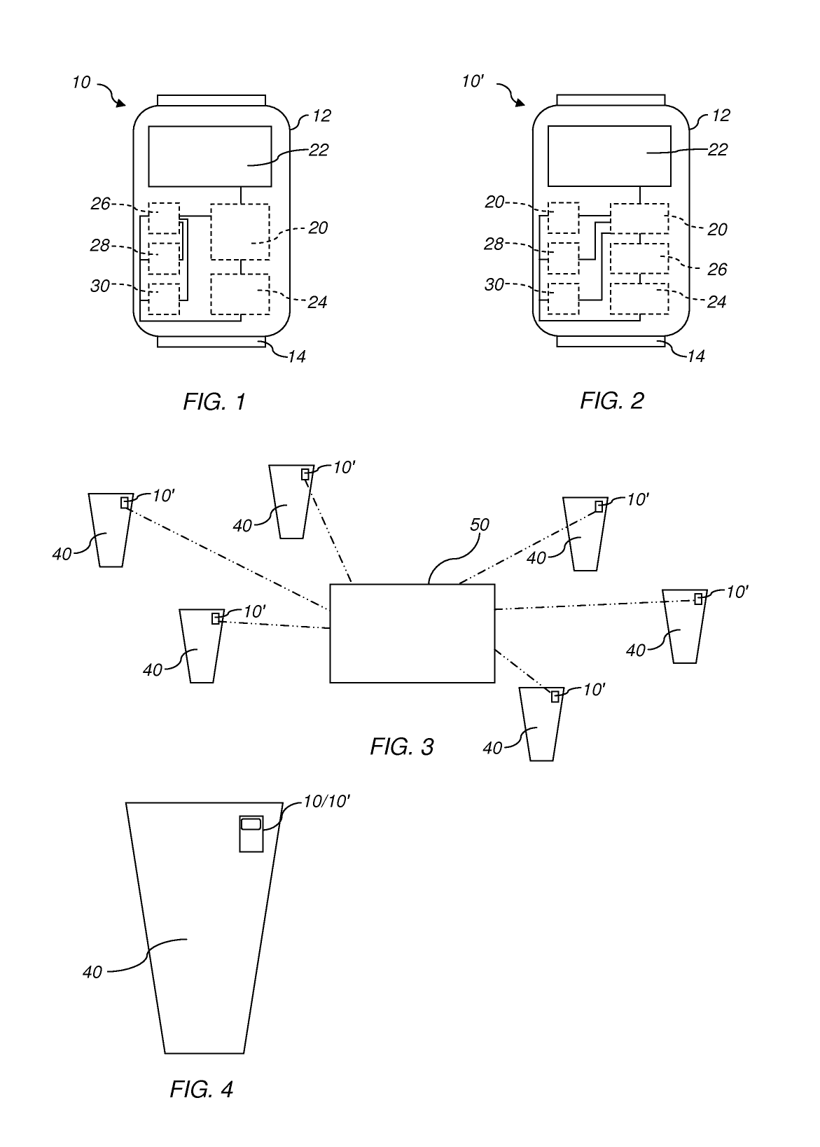

In FIG. 1, a self-contained embodiment of a tracking device 10 is illustrated. The tracking device 10 includes a housing 12, as well as a monitoring element 20 and an indicator 22 carried by the housing 12. A securing element 14 may be associated with the housing 12 to enable attachment of the housing to a medical device (not shown in FIG. 1). The tracking device 10 may also include a power supply 24, which may enable operation of one or more of the monitoring element 20, the indicator 22 and/or any other electronic components of the tracking device 10. In some embodiments, the tracking device 10 may include a processor 26 (e.g., a microprocessor, microcontroller, etc.) and, optionally, a wireless communication element 28. Of course, a tracking device 10 may include other components as well.

The securing element 14 is configured to secure the tracking device 10 to a piece of medical equipment, or a medical device, to be tracked. The configuration of the securing element 14 may depend, at least in part, upon the size or configuration of the tracking device 10, and upon the configuration of the medical device. Non-limiting examples of securing elements 14 include fasteners (e.g., cooperating hook and loop, or VELCRO®, type fasteners; snap-fit fasteners; other cooperating fastening systems; etc.), clips, or the like. The securing element 14 may be configured to mutually engage, or to be engaged by, a corresponding feature of the medical device, which may dictate the placement and/or orientation of the tracking device 10 and, thus, provide for consistent or substantially consistent placement each time a tracking device 10 is secured to a particular medical device, and/or between different medical devices of the same type and/or configuration.

Alternatively, a tracking device 10 may lack a securing element, and instead be configured for engagement by a receptacle associated with a medical device to be tracked, which may ensure consistent or substantially consistent placement and/or orientation of tracking devices 10 relative to that medical device, or between different medical devices of the same type and/or configuration. Among a wide variety of embodiments, a receptacle may comprise a pocket on the medical device, a holster secured to the medical device, or any other suitable means for securing the tracking device 10 to the medical device.

The monitoring element 20 may comprise a clock or any other element suitable for keeping track of a predetermined duration of time, or counting down from a first time to a second time. In some embodiments, the monitoring element 20 may be configured to keep a running total of the amount of time that has elapsed since the first event. In a specific embodiment, the monitoring element 20 may be set to keep track of a predetermined event, such as a date on which a piece of medical equipment is to be removed from service, when cumulative use of the medical equipment reaches a threshold that corresponds to its removal from service or any other predetermined event.

As an alternative, the monitoring element 20 may comprise one or more radiation detectors, or dosimeters. Such a monitoring element 20 may be configured to detect ionizing radiation, and may enable tracking of a cumulative exposure, or dosage, of one or more types of ionizing radiation and/or the tracking of attenuation of ionizing radiation by a medical device, such as a radio-opaque shield. The monitoring element 20 may enable tracking of a cumulative amount of ionizing radiation to which the radio-opaque shield is exposed (e.g., with an externally located element, etc.), a cumulative amount of ionizing radiation to which an individual or an object shielded by the radio-opaque shield is exposed, or a cumulative amount of ionizing radiation attenuated by the radio-opaque shield (e.g., with an element located at a shielded side of a medical device, etc.) and/or a combination of the foregoing.

The indicator 22 may be associated with the monitoring element 20 in a way that provides a user with an indication that the time for a predetermined event has come. In some embodiments, the indicator 22 may also be configured to provide an indication that the time for the predetermined event is approaching. In such embodiments, the indicator 22 may generate a perceivable signal that corresponds to an amount of time, exposure or dosage, etc., that remains before the predetermined event.

In various embodiments, the indicator 22 may be configured to provide one or more of a visible signal (e.g., a light, a text message, etc.), an audible signal (e.g., a beep, buzzer, voice message, etc.) and a tactile signal (e.g., vibration, etc.). In embodiments where the indicator 22 provides a visible signal, the indicator 22 may comprise one or more lights (e.g., light-emitting diodes (LEDs), etc.), a display screen, or the like. In embodiments where the indicator 22 provides an audio signal, it may comprise a speaker or any other suitable noise-generating component. Embodiments of indicators 22 that provide tactile signals may comprise one or more components (e.g., eccentric motors, etc.) configured to cause movement (e.g., vibration, etc.) of the tracking device 10.

In addition to, or even as an alternative to, an indicator 22 that provides notifications at the tracking device 10, the tracking device 10 may be configured to wirelessly transmit notifications. In some embodiments, such as that depicted by FIG. 1, a tracking device may include a processor 26, which may generate a signal that corresponds to a notification that is to be wirelessly transmitted, and a wireless communication element 28, which may convert the signal to an appropriate format and transmit the same to another device (e.g., a receiver, such as a monitoring station, a mobile telephone, etc.) located remotely from the tracking device 10. Without limitation, a processor 26 and wireless communication element 28 may be configured to generate and transmit text messages (e.g., short message service (SMS) messages, multimedia messaging service (MMS), other date packages, etc.) that convey information about the status of the tracking device 10, and of a medical device with which the tracking device 10 is associated.

In embodiments where a tracking device 10 includes a processor 26, the processor 26 may receive clock signals from the monitoring element 20 and, based on tracking information maintained by the tracking device 10 (e.g., by memory (not shown) associated with the processor 26, etc.), keep track of the time, exposure or dosage, etc., remaining until the predetermined event.

In some such embodiments, the tracking device 10 may also include a location element 30 (e.g., a global positioning system (GPS) receiver, etc.), which may provide information about the location of the tracking device 10 and any medical device with which the tracking device 10 is associated.

When one or both of the monitoring element 20 and the indicator 22 comprises an electronic component, or in embodiments where the tracking device 10 includes other electronic components (e.g., a processor 26, a wireless communication element 28, a location element 30, etc.), the tracking device 10 may include a power supply 24 to enable operation of each electronic component. Without limitation, the power supply 24 may comprise one or more batteries (e.g., disposable batteries, a rechargeable battery, etc.), a solar power cell, or any other type of power supply suitable for use in a portable electronic device.

Referring now to FIG. 2, an embodiment of a tracking device 10′ that has been configured for use a tracking system 1 (FIG. 3) is depicted. The tracking device 10′ may include a processor 26, an indicator 22, a power supply 24 and a wireless communication element 28. Each of these and other elements of the tracking device 10′ may be carried by a housing 12. In some embodiments, a securing element 14 may be associated with the housing 12 to secure the housing 12 and, thus, the tracking device 10′, to a piece of medical equipment, or a medical device. The securing element 14 and/or the housing 12 may be configured to ensure consistent or substantially consistent placement and/or orientation of the tracking device 10′ relative to the medical device.

Optionally, the tracking device 10′ may include one or more monitoring elements 20′ that monitor a factor other than time; for example, ionizing radiation exposure, ionizing radiation attenuation, another factor indicative of use of a particular piece of medical equipment or any other factor that can provide an indication of when a piece of medical equipment should be at least temporarily removed from use.

The processor 26 may comprise a microprocessor or a microcontroller configured to receive signals, process data carried by the signals and output signals. In the context of the tracking device 10′, the processor 26 may receive signals, through the wireless communication element 28, that relate to a predetermined event from a separate monitoring station 50 (FIG. 3). Thus, even in embodiments where the tracking device 10′ is configured to facilitate the removal of medical equipment from service based on time, the tracking device 10′ may lack a monitoring element, such as a clock. The processor 26 may cause other components of the tracking device 10′ to operate in a manner responsive to signals received by the processor 26. For example, if the monitoring station 50 signals the processor 26 to activate an indicator 22, the processor 26 may cause the indicator 22 to operate in a manner consistent with data carried by the signal. As another example, if the monitoring station 50 sends a signal requesting information on a location of a particular tracking device 10′ and its assigned medical device, the processor 26 may determine whether or not that request applies to the tracking device 10′ (e.g., by comparing a unique identifier carried by the signal to a unique identifier assigned to the tracking device 10′, etc.) and, if so, cause a location element 30 of the tracking device 10′ to obtain and provide information on a specific location of the tracking device 10′.

FIG. 3 schematically illustrates an embodiment of a tracking system 1, which may include a monitoring station 50 and a plurality of tracking devices 10′. Each tracking device 10′ may be associated with a corresponding, tracked medical device 40 (see also FIG. 4). As explained in reference to FIG. 2, each tracking device 10′ may include a wireless communication element 28, which enables communication between a processor 26 of that tracking device 10′ and the monitoring station 50.

The monitoring station 50, which may comprise a computer, may be configured to store information regarding a plurality of tracked medical devices 40, including, but not limited to, scheduling information pertaining to each of the tracked medical devices 40. As the time for a predetermined event for a particular tracked medical device 40 approaches, the monitoring station 50 may signal the tracking device 10′ associated with that tracked medical device 40 (e.g., by use of a unique identifier, etc.) to provide an indication that the time for the predetermined event is arriving or has arrived. The monitoring station 50 may also be configured to request confirmation that the predetermined event has been completed and, in the event that no confirmation is provided, periodically follow up with subsequent requests for confirmation.

In some embodiments, the monitoring station 50 may also be configured to store information corresponding to a physical (e.g., geographical, etc.) location of each tracked medical device 40. If the time for a predetermined event for a particular tracked medical device 40 arrives, but the monitoring station 50 does not receive confirmation that the predetermined event has occurred, the monitoring station 50 may provide information on the current location of the tracked medical device 40.

Turning now to FIG. 4, an embodiment of a tracked medical device 40 is depicted. In the illustrated embodiment, the tracked medical device 40 comprises an apron for attenuating ionizing radiation, such as x-rays, gamma radiation, or the like. However, the illustrated embodiment should not be considered to limit the types of medical devices that may be tracked in accordance with teachings of this disclosure. The tracked medical device 40 carries a tracking device 10, 10′, such as those depicted by and described in reference to FIGS. 1 and 2, or any other suitable embodiment of device for directly associating a predetermined event (e.g., removal of the tracked medical device 40 from operation for inspection, validation, maintenance, disposal, etc.; etc.) with a particular medical device 40. In some embodiments, the tracking device 10, 10′ may be removably secured to the tracked medical device 40. In other embodiments, the tracking device 10, 10′ may be permanently secured to the tracked medical device 40. As another alternative, the tracking device 10, 10′ may be integrated into the design of the tracked medical device 40 and, thus, comprise a part of the tracked medical device 40. In any of these events, the location of the tracking device 10, 10′ relative to the medical device 40 may be fixed or substantially fixed from one medical device 40 to another medical device 40 of the same type and/or configuration.

In an example of use, an individual (e.g., a person using the assigned medical equipment, a person tasked with inventory control responsibilities, a person responsible for ensuring that the medical equipment is in compliance with inspection, compliance and/or validation requirements, etc.) may optionally secure a tracking device 10, 10′, etc., to a tracked medical device 40.

With the tracking device 10, 10′, etc., in place, it may be activated. In embodiments where the tracking device 10, 10′ is used to identify when a tracked medical device 40 is to be at least temporarily removed from service based on the amount of time the tracked medical device 40 has been in service, activation of the tracking device 10, 10′, etc., may include identification of a first point in time at which the tracked medical device 40 has been calibrated, validated, placed into service, etc. Activation of the tracking device 10, 10′, etc., in such an embodiment may also include setting or scheduling a second point in time at which a reminder is to be provided. The duration of time between the first point in time and the second point in time may be predetermined (e.g., it may correspond to a useful life; a regular, periodic schedule; etc.) or it may be defined during the activation process. Activation of the tracking device 10, 10′ may also include initiating a count down from the first point in time to the second point in time or monitoring an amount of time remaining until the second point in time.

In embodiments where a tracked medical device 40 is removed from service based on its use, activation of a tracking device 10, 10′ may include setting a threshold level of use for the device.

With the tracking device 10, 10′, etc., activated, an individual who is responsible for collecting the tracked medical device 40 and at least temporarily removing the same from operation in accordance with a predetermined event need not actively monitor the location or the status of the tracked medical device 40. Rather, the individual may take a passive approach to his or her responsibilities, waiting for an indication that a predetermined event is approaching or has arrived, then removing the tracked medical device 40 from operation, and performing the predetermined event.

As the predetermined event (i.e., the second point in time, the threshold level of use, etc.) approaches or arrives, the tracking device 10, 10′, etc., may provide (e.g., output, etc.) a user perceivable indication that corresponds to the predetermined event. As that indication is provided, a predetermined event may occur (e.g., the tracked medical device 40 may be removed from service, an individual's exposure to ionizing radiation may be limited or terminated for a period of time (e.g., the rest of a day, a week, a month, a year, etc.), etc.) and the indication provided by the tracking device 10, 10′, etc., may be turned off and optionally removed from the tracked medical device 40. In some embodiments, the tracked medical device 40 may be inspected, validated or maintained. After the tracked medical device 40 has been inspected, validated or maintained, or another predetermined event has occurred (e.g., the end of a period of time during which an individual's exposure to ionizing radiation is limited or eliminated, etc.) an event tracker, which enables determination of whether or not the predetermined event has occurred (e.g., by cumulating events, such as passage of time, exposure to ionizing radiation, etc.), may be reset.

Although the foregoing description contains many specifics, these should not be construed as limiting the scope of any of the appended claims, but merely as providing information pertinent to some specific embodiments that may fall within the scopes of the appended claims. Other embodiments may also be devised which lie within the scopes of the appended claims. Features from different embodiments may be employed in combination. The scope of the invention is, therefore, indicated and limited only by the appended claims and their legal equivalents. All additions, deletions and modifications to the disclosed embodiments that fall within the meaning and scopes of the appended claims are to be embraced thereby.

What is claimed:

1. A tracking device for monitoring a status of a radio-opaque shield, comprising:
a securing element configured for attachment to a radio-opaque shield;
a monitoring element comprising a radiation detector configured for tracking a cumulative dose of ionizing radiation, from a first event to a subsequent, second event; and
a user perceivable indicator associated with the monitoring element, the user perceivable indicator configured to provide an output indicative of the second event.

2. The tracking device of claim 1, wherein the monitoring element is configured to track the cumulative dose of radiation from the first event, comprising an initial use of the radio-opaque shield, to the second event, comprising a removal of the radio-opaque shield from service.

3. The tracking device of claim 2, wherein the initial use of the radio-opaque shield comprises initial use of a new radio-opaque shield or initial use of a radio-opaque shield following a schedule inspection, a scheduled validation or a scheduled maintenance.

4. The tracking device of claim 1, wherein the cumulative dose of ionizing radiation monitored by the monitoring element comprises a cumulative dose of ionizing radiation to which the radio-opaque element is exposed over time.

5. The tracking device of claim 1, wherein the cumulative does of ionizing radiation monitored by the monitoring element comprises a cumulative amount of ionizing radiation attenuated by the radio-opaque element over time.

6. The tracking device of claim 1, wherein the user perceivable indicator is configured to provide an output indicative of a cumulative dose of ionizing radiation from the first event or a cumulative dose of radiation remaining until the second event.

7. The tracking device of claim 1, further comprising:
a unique identifier.

8. The tracking device of claim 7, wherein the unique identifier comprises a visible identifier.

9. The tracking device of claim 7, wherein the unique identifier comprises an electronic identifier.

10. The tracking device of claim 1, further comprising:
a processor; and
a wireless communication element for establishing communication between the processor and a monitoring station remote from the tracking device.

11. The tracking device of claim 1, wherein the securing element is configured to ensure substantially consistent placement and orientation of the tracking device on a plurality of radio-opaque shields of the same type or configuration.

12. An apparatus for attenuating ionizing radiation, comprising:
a radio-opaque shield; and
a tracking device secured to the radio-opaque shield, the tracking device including:
a monitoring element comprising a radiation detector configured for tracking a cumulative dose of ionizing radiation, from a first event to a subsequent, second event; and
a user perceivable indicator associated with the monitoring element, the user perceivable indicator configured to provide an output indicative of the second event.

13. The apparatus of claim 12, wherein the tracking device is permanently secured to the radio-opaque shield.

14. The apparatus of claim 13, wherein the radio-opaque shield includes a receptacle for the tracking device and the tracking device is engaged by the receptacle.

15. The apparatus of claim 12, wherein the tracking device is part of the radio-opaque shield.

16. The apparatus of claim 12, wherein the cumulative dose of ionizing radiation monitored by the monitoring element comprises a cumulative dose of ionizing radiation to which the radio-opaque shield is exposed over time.

17. The apparatus of claim 12, wherein the cumulative does of ionizing radiation monitored by the monitoring element comprises a cumulative amount of ionizing radiation attenuated by the radio-opaque shield over time.

18. The apparatus of claim 12, wherein at least one of the radio-opaque shield and the securing element is configured to ensure substantially consistent placement and orientation of the tracking device on a plurality of radio-opaque shields of the same type or configuration.

19. A system for tracking a plurality of medical devices, comprising:
a monitoring station;
a plurality of radio-opaque shields, each radio-opaque shield of the plurality to be inspected, validated or maintained upon tracking a threshold dose of ionizing radiation over time;
a plurality of tracking devices, each tracking device of the plurality of tracking devices being configured to be used with a radio-opaque shield of the plurality of radio-opaque shields and including:
a securing element configured to secure the tracking device to the radio-opaque shield;
a processor;
a user perceivable indicator associated with the processor; and
a wireless communication component associated with the processor to enable the processor to communicate remotely with the monitoring station,
at least one of the monitoring station and the processor of each of the plurality of tracking devices comprising a monitoring element configured to enable determination of exposure of the tracking device to the threshold dose of ionizing radiation, upon which the medical device is to be inspected, validated or maintained, the user perceivable indicator configured to provide an output when the tracking device has been exposed to the threshold does of ionizing radiation.

20. The system of claim 19, further comprising:
a unique identifier associated with each medical device of the plurality of radio-opaque shield.

21. The system of claim 20, wherein the unique identifier is carried by the tracking device associated with the radio-opaque shield.

22. The system of claim 21, wherein the monitoring station tracks a cumulative dose of ionizing radiation to which each radio-opaque shield is exposed based on the unique identifier carried by the tracking device associated with that radio-opaque shield, the monitoring station being configured to send a signal to the tracking device associated with that radio-opaque shield when the predetermined event occurs for that radio-opaque shield, the signal causing the processor of the tracking device associated with that radio-opaque shield to operate the user perceivable indicator of the tracking device.

23. The system of claim 19, further comprising:
equipment for inspecting, validating or maintaining the plurality of radio-opaque shields.

24. The apparatus of claim 19, wherein:
the plurality of radio-opaque shields are of the same type or have the same configuration; and
the plurality of radio-opaque shields or the securing elements of the plurality of tracking devices are configured to ensure substantially consistent placement and orientation of the plurality of tracking devices on the plurality of radio-opaque shields.

25. A method for inspecting, validating or maintaining a plurality of medical devices within a healthcare setting, comprising:
occasionally monitoring a tracking device corresponding to each radio-opaque shield of a plurality of radio-opaque shields to identify a cumulative dose of ionizing radiation to which the tracking device has been exposed since placement of the radio-opaque shield into service; and
upon perceiving an indicator from the tracking device indicative of a threshold dose of ionizing radiation over time, at least temporarily removing the radio-opaque shield from service.

26. The method of claim 25, further comprising:
inspecting, validating or maintaining the medical device after at least temporarily removing the radio-opaque shield from service.

27. The method of claim 26, further comprising:
after inspecting, validating or maintaining, resetting an event tracker associated with the tracking device.

28. The method of claim 27, further comprising:
after resetting the event tracker, placing the radio-opaque shield back into service.

29. The method of claim 25, further comprising:
placing the tracking device at a monitoring location on a first radio-opaque shield of a particular type or configuration.

30. The method of claim 29, further comprising:
removing the tracking device from the first radio-opaque shield; and
placing the tracking device at a monitoring location on a second radio-opaque shield of the particular type or configuration, the monitoring location on the first radio-opaque shield and the monitoring location on the second radio-opaque shield being substantially the same.

31. The method of claim 25, further comprising:
placing a plurality of tracking devices on monitoring locations on a plurality of radio-opaque shields of a same type or configuration, the monitoring locations on the plurality of radio-opaque shields being substantially the same.
